(19) United States
(12) Patent Application Publication
(10) Pub. No.: US 2012/0064410 A1
(43) Pub. Date: Mar. 15, 2012

(54) POSITIVE ELECTRODE PLATE, METHOD OF MANUFACTURING THE SAME, AND LITHIUM BATTERY INCLUDING THE POSITIVE ELECTRODE PLATE

(75) Inventors: Ji-Hyun Kim, Yongin-si (KR); Do-Hyung Park, Yongin-si (KR); Seong-Young Kwon, Yongin-si (KR); Min-Han Kim, Yongin-si (KR); Jeong-Seop Lee, Yongin-si (KR); Chang-Hyuk Kim, Yongin-si (KR)

(73) Assignee: Samsung SDI Co., Ltd., Yongin-si (KR)

(21) Appl. No.: 13/103,955

(22) Filed: May 9, 2011

(30) Foreign Application Priority Data
Sep. 9, 2010 (KR) 10-2010-0088464

(51) Int. Cl. H01M 4/485; H01M 4/52; H01M 4/505; H01M 4/28; H01M 4/50

(52) U.S. Cl. 429/223; 29/623.1; 29/623.5

(57) ABSTRACT

A positive electrode plate, a method of manufacturing the same, and a lithium battery including the positive electrode plate are disclosed. The positive electrode plate comprises particles of a nickel-based composite oxide represented by Formula 1, wherein the particles have an average particle diameter D₅₀ of about 10 μm to about 20 μm, wherein 1 wt % or less of the particles has a diameter of about 5 μm or less, wherein Formula 1 is LiNiₓCo_{y}Mn_{1-x-y}O₂, and wherein 0<x<1.0, 0<y<1.0, and x+y<1.

### RELATED APPLICATIONS

This application claims the benefit of Korean Patent Application No. 10-2010-0088464, filed Sep. 9, 2010, in the Korean Intellectual Property Office, the disclosures of which are incorporated herein by reference.

### BACKGROUND

1. Field

Embodiments of the present invention relate to a positive electrode plate, a method of manufacturing the same, and a lithium battery including the positive electrode plate.

2. Description of the Related Technology

Recently, lithium batteries have drawn significant attention as power sources for small portable electronic devices. Lithium batteries using an organic electrolyte typically have a discharge voltage about twice as high as those using an aqueous alkali electrolyte, and have higher energy density.

Lithium batteries have widely been adopted as power sources for portable electronic devices due to their high voltage, high energy density, and good safety characteristics. However, recent demands for portable electronic devices with higher capacities and smaller sizes and weights have required lithium batteries to have higher driving voltages, longer life spans, and higher energy densities than those currently available. In order to satisfy these demands, ongoing effort is made to enhance performances of various components of lithium batteries.

Several types of lithium batteries are available. Recently, those batteries using lithium cobalt composite oxide (LiCoO₂, hereinafter, “LCO”) as a positive active material are most widely used. However, uneven distribution and the scarcity of material supplies of cobalt (Co) increase manufacturing costs of lithium batteries, hindering a stable supply.

In order to address these issues, it has been endeavored to adopt suitable alternatives to Co. As a result, active materials using nickel (Ni) or manganese (Mn), which are less costly than Co, individually or in combination, are being developed. However, currently used low-cost, high-capacity, and low-voltage positive active materials such as nickel-based composite oxide may become structurally unstable as a larger amount of lithium is deintercalated as when LCO is used. Thus, these positive active materials are more likely to decompose and to deteriorate capacity during charge and discharge cycles. In addition, the unstable structure of such positive active materials may lead to deintercalation of oxygen along with lithium ions from the positive active materials, which become more prone thereto at higher temperatures, leading to deterioration in capacity of the positive active materials. Furthermore, the positive active materials may react with an electrolyte, and thus may become more unstable to heat. This may worsen if positive active material particles are broken by rolling and thus have larger specific surface area, becoming more vulnerable to side reactions with the electrolyte.

Therefore, there is a demand for positive active materials that does not have the drawbacks of conventional technologies, with improved stability against electrolytes.

### SUMMARY

One or more embodiments of the present invention include a positive electrode plate with good charge/discharge characteristics and stability.

One or more embodiments of the present invention include a method of manufacturing the positive electrode plate.

One or more embodiments of the present invention include a lithium battery including a positive electrode that includes the positive electrode plate.

According to one or more embodiments of the present invention, a positive electrode plate includes particles of a nickel-based composite oxide represented by Formula 1, wherein the nickel-based composite oxide has an average particle diameter D₅₀ of about 10 μm to about 20 μm, and wherein 1 wt % or less of a cumulative distribution of particles has a diameter of about 5 μm or less:

LiNiₓCo_{y}Mn_{1-x-y}O₂ Formula 1
wherein 0<x<1.0, 0<y<1.0, and x+y<1.

The particles may have a spherical particle shape and a specific surface area of about 0.2 m²/g to about 0.5 m²/g.

The nickel-based composite oxide may have a porosity of about 1% to about 40%.

The nickel-based composite oxide may have a density of about 1 g/cm³ to about 5 g/cm³.

In Formula 1, x may be from 0.3 to 0.65, and y may be less than 0.35.

The nickel-based composite oxide may have a compressive fracture strength (CFS) of 50 MPa or greater.

According to one or more embodiments of the present invention, a method of manufacturing a positive electrode plate includes: providing a mixed solution comprising a nickel (Ni)-containing compound, a cobalt (Co)-containing compound, a manganese (Mn)-containing compound, a precipitating agent, and a chelating agent; co-precipitating the mixed solution at a pH of about 10 to about 12 to obtain a nickel-based composite oxide precursor; mixing and sintering the nickel-based composite oxide precursor and a lithium-containing compound to obtain a nickel-based composite oxide; coating the nicked-based composite oxide on a current collector; and drying and rolling the coated current collector.

The Ni-containing material may include at least one compound selected from the group consisting of nickel oxides, nickel hydroxides, nickel carbonates, nickel nitrides, nickel sulfides, nickel halides, and carboxylic acid nickel salts. The Co-containing material may include at least one compound selected from the group consisting of cobalt oxides, cobalt hydroxides, cobalt halides, and carboxylic acid cobalt salts. The Mn-containing compound may include at least one compound selected from the group consisting of manganese oxides, manganese carbonates, manganese nitrides, manganese sulfides, manganese halides, and carboxylic acid manganese salts.

The sintering may be performed at a temperature of about 800° C. to about 1000° C.

The nickel-based composite oxide precursor and the lithium-containing compound may be mixed in a ratio of about 1:1 to about 1.1:1 by weight.

According to one or more embodiments of the present invention, a lithium battery includes: a positive electrode including the positive electrode plate described above; a negative electrode; and a separator between the positive and negative electrodes.

Additional aspects will be set forth in part in the description which follows and, in part, will be apparent from the description, or may be learned by practice of the presented embodiments.

### BRIEF DESCRIPTION OF THE DRAWINGS

These and/or other aspects will become apparent and more readily appreciated from the following description of the embodiments, taken in conjunction with the accompanying drawings of which:

FIG. 1 is a schematic perspective view of a lithium battery according to an embodiment of the present invention;

FIGS. 2A and 2B are scanning electron microscopic (SEM) images of a positive active material of Example 1 before and after being rolled, respectively;

FIGS. 3A and 3B are SEM images of a positive active material of Comparative Example 1 before and after being rolled, respectively;

FIG. 4 is a graph of particle diameter distribution of the positive active material of Example 1 before and after being rolled;

FIG. 5 is a graph of particle diameter distribution of the positive active material of Comparative Example 1 before and after being rolled;

FIG. 6 is differential scanning calorimetric (DSC) plots of lithium batteries manufactured in Example 1 and Comparative Example 1; and

FIG. 7 is a graph of capacity versus number of cycles of the lithium batteries of Example 1 and Comparative Example 1.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

Hereinafter, one or more embodiments of a positive electrode plate, a method of manufacturing the same, and a lithium battery including the positive electrode plate will be described in greater detail.

According to an embodiment of the present invention, a positive electrode plate may include a positive active material including a nickel-based composite oxide represented by Formula 1 below, wherein the nickel-based composite oxide has an average particle diameter D₅₀ of about 10 μm to about 20 μm, and 1 wt % or less of an accumulative distribution of particles having a diameter of about 5 μm or less:

LiNiₓCo_{y}Mn_{1-x-y}O₂ Formula 1

For example, the positive electrode plate may be manufactured by coating a current collector with the positive active material, and drying and rolling the coated current collector.

Higher-capacity batteries may be manufactured by either using inherently high capacity electrode materials or using mechanical methods for increasing the density of the electrodes. In the former, metals, such as lithium, having high electric capacity may be used. In the latter, electrodes may be compressed by, for example, rolling, to increase the density of the electrodes. An electrode including a nickel-based positive active material may also be compressed by, for example, rolling, to attain a higher density. However, side reactions may occur between the electrode and an electrolyte when a battery is continuously charged and discharged for a long time, in particular, at high temperatures. In this regard, it is understood that H₂O and LiPF₆ in the electrolyte react to produce strong acid HF, which then attacks Ni on surfaces of the nickel-based positive active material, causing Ni to flow out into the electrolyte. The side reactions, in which Ni of the nickel-based positive active material flows out into the electrolyte, can break down the nickel-based positive active material, thereby remarkably reducing the lifetime of a battery. The side reactions may be inhibited by coating or doping the surfaces of the nickel-based positive active material with a material having low reactivity with the electrolyte. Alternatively, inherent characteristics of the positive active material may be controlled to enhance particle strength to increase durability against rolling, and may have reduced specific surface area, to reduce the occurrence of the side reactions with the electrolyte.

The positive active material, including the nickel-based composite oxide, may have strong particle strength, and thus may have an average particle diameter D₅₀ of about 10 μm to about 20 μm and include about 1 weight % or less of particles having a diameter of about 5 μm or less, based on 100 weight % of all particles of the positive active material, after rolling.

The average particle diameter D₅₀ refers to an average particle diameter at a point corresponding to 50% volume based on the total volume 100% on an accumulation curve of a particle size distribution of all nickel-based composite oxide particles.

The term “rolling” refers to a process involved in manufacturing batteries to enhance density and crystallinity of active materials, wherein active material layers are pressed several times using a specific pressure.

The nickel-based composite oxide particles having an average particle diameter of about 5 μm or less may fill spaces between particles of an average particle diameters of about 10 μm and about 20 μm, so that charge density may be increased, and relatively smaller particles may less likely break. When the average particle diameter of the nickel-based composite oxide and the amount of the particles having a particle diameter of about 5 μm or less after rolling are within the ranges defined above, the nickel-based composite oxide particles may not break and have reduced specific surface area.

The amount of the particles having an average particle diameter of about 5 μm or less may be increased by about one time to about 1.2 times by rolling. The density of the positive active material may also increase by rolling, though some of the positive active material particles may break by force applied during rolling. The positive active material including the nickel-based composite oxide after rolling may have an average particle diameter D₅₀ of about 10 μm to about 20 μm and may include a relatively small amount of particles having a particle diameter of about 5 μm or less, which indicates that most of the nickel-based composite oxide particles remains intact after rolling.

The nickel-based composite oxide particles may have spherical shapes and may have a specific surface area of about 0.2 m²/g to about 0.5 m²/g. When the nickel-based composite oxide particles are spherical and have a specific surface area within this range, the area that reacts to the electrolyte can be relatively small so as to suppress side reactions with the electrolyte, and thus the stability of the battery may be improved.

The specific surface area of the nickel-based composite oxide can be measured using a Brunauer-Emmett-Teller (B.E.T.) surface area analyzer.

The porosity of the nickel-based composite oxide particles may be from about 0.01% to about 30%.

When the porosity of the nickel-based composite oxide particles is within this range, the area of reaction with the electrolyte may be sufficiently small as to suppress side reactions, and thus the battery may have improved performance.

Density of the nickel-based composite oxide may vary according to conditions of the rolling. For example, the nickel-based composite oxide may have a density of about 1 g/cm³ to about 5 g/cm³.

In the nickel-based composite oxide of Formula 1 above, x may be from 0.3 to 0.65, and y may be less than 0.35. However, x and y may be any of various numbers.

However, the nickel-based composite oxide having such a composition that x and y fall within these ranges may be structurally stable and have good electrochemical characteristics even when operating at high voltages.

The nickel-based composite oxide may have a compressive fracture strength (CFS) of about 50 MPa or greater.

When the CFS of the nickel-based composite oxide is within this range, a compressive stress energy applied when the nickel-based composite oxide is densified is not used to break down the nickel-based composite oxide particles; rather, it is exerted on individual nickel-based composite oxide particles to position the particles nearer to each other to make the oxide more dense.

For example, the nickel-based composite oxide after the rolling may have a CFS of about 50 MPa to about 300 MPa, and in some embodiments, a CFS of about 50 MPa to about 100 MPa.

According to an embodiment of the present invention, a method of manufacturing the positive electrode plate includes: mixing a nickel (Ni)-containing compound, a cobalt (Co)-containing compound, a manganese (Mn)-containing compound, a precipitating agent, and a chelating agent to obtain a mixed solution; co-precipitating the mixed solution at a pH of about 10 to about 12 to obtain a nickel-based composite oxide precursor; mixing the nickel-based composite oxide precursor and a lithium (Li)-containing compound to obtain a mixture, and sintering the mixture to obtain a nickel-based composite oxide; and coating the nickel-based composite oxide on a current collector, and drying and rolling the resulting structure.

Examples of the Ni-containing material include: nickel nitrides, such as NiO and NiO₂; nickel hydroxides, such as Ni(OH)₂, NiOOH, and 2Ni(OH)₂.4H₂O; nickel carbonates; nickel nitrates, such as Ni(NO₃)₂.6H₂O; nickel sulfates, such as NiSO₄ and NiSO₄.6H₂O; nickel halides; nickel acetates; and carboxylic acid nickel salts. A combination of at least two of these examples may also be used.

Examples of the Co-containing material include: cobalt oxides, such as CoO, CO₂O₃, and Co₃O₄; cobalt hydroxides, such as Co(OH)₂; cobalt halides; and carboxylic acid cobalt salts, such as Co(OCOCH₃)₂.4H₂O. A combination of at least two of these examples may also be used.

Examples of the Mn-containing material include: manganese oxides, such as Mn₂O₃, MnO₂, and Mn₃O₄; manganese carbonates; manganese nitrides, such as Mn(NO₃)₂; manganese sulfides, such as MnSO₄; manganese halides; and carboxylic acid manganese salts, such as manganese acetates and manganese citrate. A combination of at least two of these examples may also be used.

The Ni-containing compound, the Co-containing compound, and the Mn-containing compound are each dissolved in water before use. The Ni-containing compound, the Co-containing compound, and the Mn-containing compound may have a purity of 99% or greater.

The precipitating agent may be a NaOH solution, a KOH solution, or a combination thereof. However, any suitable solution including an OH-group may be used as the precipitating agent.

The chelating agent may be NH₄OH, NH₄H₂PO₄, (NH₄)₂HPO₄, or a combination thereof. However, any suitable compound including an ammonia group may be used. Ammonia acts as a ligand to lower the energy level of a d-orbital of the metal ion and then reacts with an —OH group to produce a compound including the —OH group.

The nickel-based composite oxide of Formula 1 may be synthesized by any common method used in the art, for example, by a solid-phase method, co-precipitation, or the like.

The solid-phase method may involve: mixing the Ni-containing compound, the Co-containing compound and the Mn-containing compound in a solid state to obtain a mixture; and sintering the mixture to obtain the nickel-based composite oxide. The co-precipitation method may involve: dissolving the Ni-containing compound, the Co-containing compound and the Mn-containing compound in a liquid state, for example, in a NaOH solution to obtain a mixed solution; obtaining a precursor from the solution by co-precipitation; and drying the precursor and mixing it with Li₂CO₃, and sintering the mixture to obtain the nickel-based composite oxide.

For example, the nickel-based composite oxide of Formula 1 may be prepared by co-precipitation as follows: mixing a Ni-containing compound, a Co-containing compound, a Mn-containing compound, an NaOH solution, and NH₄OH to obtain a mixed solution; co-precipitating the mixed solution at a pH of about 10 to about 12 to obtain a nickel-based composite oxide precursor; and mixing the precursor and an Li-containing compound to obtain a mixture and sintering the mixture.

The amount of NaOH may be chosen to be within an appropriate range to facilitate co-precipitation and for the lithium battery to have improved charge/discharge cycle characteristics. For example, about 70 parts to about 90 parts by weight of a 4-8M NaOH solution based on 100 parts by weight of all metal-containing compounds.

NH₄OH may act as a chelating agent. The amount of NH₄OH may also be chosen to be within an appropriate range to facilitate chelating and for the lithium battery to have improved charge/discharge cycle characteristics. For example, the amount of NH₄OH may be from about 10 parts to about 50 parts by weight based on 100 parts by weight of all metal-containing compounds.

The nickel-based composite oxide precursor may be obtained by co-precipitating the mixed solution at a pH of about 10 to about 12. The co-precipitation may be performed at any appropriate temperature and any appropriate pH range. Co-precipitation conditions may be appropriately chosen.

The nickel-based composite oxide precursor may include a precursor of nickel to form a nickel-containing metal oxide, and precursors of other metals, including lithium. The nickel-based composite oxide precursor may be in any of various forms, for example, a metal salt, a metal complex coordinated with an organic ligand, or the like. The amounts of individual precursors of the metals of the nickel-based composite oxide precursor may be appropriately chosen according to the composition of a metal-containing metal oxide that is to be formed.

The nickel-based composite oxide precursor may be mixed with Li₂CO₃ in a 1:1 to 1.1:1 ratio by weight after being washed and dried. Then, the resulting mixture is finally sintered to obtain the nickel-based composite oxide of Formula 1.

The sintering may be performed at a temperature of about 800° C. to about 1000° C. while dry air is supplied. The sintering time may appropriately vary according to the sintering temperature. For example, the sintering may be performed for about 10 hours to about 20 hours.

The resulting nickel-based composite oxide may be coated on a current collector, dried, and rolled to obtain the positive electrode plate.

According to an embodiment of the present invention, a positive electrode includes the positive electrode plate including the positive active material, The positive active material may include a nickel-based composite oxide represented by Formula 1 above, wherein the nickel-based composite oxide may have an average particle diameter D₅₀ of about 10 μm to about 20 μm, and 1 wt % or less of a cumulative distribution of particles having a diameter of about 5 μm or less.

The positive electrode may include a current collector and a binder, in addition to the positive active material, as in typical positive electrodes of lithium batteries. The positive electrode may further include a conducting agent if required. In this regard, the amounts of the positive active material, the conductive material, the binder, and the solvent may be the same level as those used in a conventional lithium battery.

According to another embodiment of the present invention, a lithium battery includes the positive electrode described above.

The lithium battery may include the positive electrode, a negative electrode, and a separator between the positive and negative electrodes, as in typical lithium batteries.

For example, the positive electrode may be manufactured by molding a mixed positive electrode material including the positive active material and a binder into a desired shape, or coating the mixed positive electrode material on a current collector such as a copper foil, an aluminum foil, or the like. For example, after the positive active material, a binder, a conducting agent, and a solvent may be mixed to obtain a mixed positive electrode material, and the mixed positive electrode material may be coated directly on an aluminum foil current collector to manufacture the positive electrode. Alternatively, the positive electrode may be manufactured by casting the mixed positive electrode material on a separate support to form a positive active material film, which may then be separated from the support and laminated on an aluminum foil current collector. The positive electrode is not limited to the examples described above, and may be one of a variety of types.

The positive active material may include the nickel-based composite oxide of Formula 1 above. For example, the positive active material may include the nickel-based composite oxide of Formula 1 alone or a combination of the nickel-based composite oxide of Formula 1 and one of compounds represented by the following formulas:

LiₐA_{1-b}X_{b}D₂ (wherein 0.95≦a≦1.1, and 0≦b≦0.5); LiₐE_{1-b}X_{b}O_{2-c}D_{c} (wherein 0.95≦a≦1.1, 0≦b≦0.5, and 0≦c≦0.05); LiE_{2-b}X_{b}O_{4-c}D_{c} (wherein 0≦b≦0.5, and 0≦c≦0.05); LiₐNi_{1-b-c}Co_{b}B_{c}D_{α} (wherein 0.95≦a≦1.1, 0≦b≦0.5, 0≦c≦0.05, and 0<α≦2); LiₐNi_{1-b-c}Co_{b}X_{c}O_{2-α}M_{α} (wherein 0.95≦a≦1.1, 0≦b≦0.5, 0≦c≦0.05, and 0<α<2); LiₐNi_{1-b-c}Co_{b}X_{c}O_{2-α}M₂ (wherein 0.95≦a≦1.1, 0≦b≦0.5, 0≦c≦0.05, and 0<α<2); LiₐNi_{1-b-c}Mn_{b}X_{c}D_{α} (wherein 0.95≦a≦1.1, 0≦b≦0.5, 0≦c≦0.05, and 0<α≦2); LiₐNi_{1-b-c}Mn_{b}X_{c}O_{2-α}M₂ (wherein 0.95≦a≦1.1, 0≦b≦0.5, 0≦c≦0.05, and 0<α<2); LiₐNi_{1-b-c}Mn_{b}X_{c}O_{2-α}M₂ (wherein 0.95≦a≦1.1, 0≦b≦0.5, 0≦c≦0.05, and 0<α<2); LiₐNi_{b}E_{c}G_{d}O₂ (wherein 0.90≦a≦1.1, 0≦b≦0.9, 0≦c≦0.5, and 0.001≦d≦0.1); LiₐNi_{b}Co_{c}Mn_{d}GₑO₂ (wherein 0.90≦a≦1.1, 0≦b≦0.9, 0≦c≦0.5, 0≦d≦0.5, and 0.001≦e≦0.1); LiₐNiG_{b}O₂ (wherein 0.90≦a≦1.1, and 0.001≦b≦0.1); LiₐCoG_{b}O₂ (wherein 0.90≦a≦1.1, and 0.001≦b≦0.1); LiₐMnG_{b}O₂ (wherein 0.90≦a≦1.1, and 0.001≦b≦0.1); LiₐMn₂G_{b}O₄ (wherein 0.90≦a≦1.1, and 0.001≦b≦0.1); QO₂; QS₂; LiQS₂; V₂O₅; LiV₂O₅; LiZO₂; LiNiVO₄; Li_{(3-f)}J₂(PO₄)₃(0≦f≦2); Li_{(3-f)}Fe₂(PO₄)₃(0≦f≦2); and LiFePO₄.

In the formulas above, A may be selected from the group consisting of nickel (Ni), cobalt (Co), manganese (Mn), and combinations thereof; X may be selected from the group consisting of aluminum (Al), nickel (Ni), cobalt (Co), manganese (Mn), chromium (Cr), iron (Fe), magnesium (Mg), strontium (Sr), vanadium (V), a rare earth element, and combinations thereof; D may be selected from the group consisting of oxygen (O), fluorine (F), sulfur (S), phosphorus (P), and combinations thereof; E may be selected from the group consisting of cobalt (Co), manganese (Mn), and combinations thereof; M may be selected from the group consisting of fluorine (F), sulfur (S), phosphorus (P), and combinations thereof; G may be selected from the group consisting of aluminum (Al), chromium (Cr), manganese (Mn), iron (Fe), magnesium (Mg), lanthanum (La), cerium (Ce), strontium (Sr), vanadium (V), and combinations thereof; Q may be selected from the group consisting of titanium (Ti), molybdenum (Mo), manganese (Mn), and combinations thereof; Z may be selected from the group consisting of chromium (Cr), vanadium (V), iron (Fe), scandium (Sc), yttrium (Y), and combinations thereof; and J may be selected from the group consisting of vanadium (V), chromium (Cr), manganese (Mn), cobalt (Co), nickel (Ni), copper (Cu), and combinations thereof.

The compounds listed above as positive active materials may have a surface coating layer (hereinafter, “coating layer”). Alternatively, a mixture may be used that includes a compound without a coating layer and a compound having a coating layer, the compounds being selected from the compounds listed above. The coating layer may include at least one compound of a coating element selected from oxides, hydroxides, oxyhydroxides, oxycarbonates, and hydroxycarbonates of the coating element. The compounds for the coating layer may be amorphous or crystalline. The coating element for the coating layer may be magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or mixtures thereof.

The coating layer may be formed using any appropriate method that does not adversely affect physical properties of the positive active material when a compound of the coating element is used. For example, the coating layer may be formed using spray-coating, dipping, or the like.

The binder may facilitate binding between the positive active material and the conducting agent, and binding of the positive active material to the current collector. Examples of the binder may include polyvinylidene fluoride (PVDF), polyvinyl alcohols, carboxymethylcellulose (CMC), starch, hydroxypropylcellulose, regenerated cellulose, polyvinylpyrollidone, tetrafluoroethylene, polyethylene, polypropylene, ethylene-propylene-diene terpolymer (EPDM), sulfonated EPDM, styrene butadiene rubber, fluoro rubber, and various copolymers.

The conducting agent is not particularly limited, and may be any of various materials so long as it has a suitable conductivity without causing chemical changes in the battery. Examples of the conducting agent include graphite, such as natural or artificial graphite; carbon blacks, such as acetylene black, Ketjen black, channel black, furnace black, lamp black, and thermal black; conductive fibers, such as carbon fibers and metallic fibers; metallic powders, such as carbon fluoride powder, aluminum powder, and nickel powder; conductive whiskers, such as zinc oxide and potassium titanate; conductive metal oxides, such as titanium oxide; and polyphenylene derivatives.

The solvent may be any solvent that is commonly used in batteries. For example, the solvent may be N-methylpyrrolidone (NMP), acetone, water, or the like.

The amounts of the positive active material, the binder, the solvent, and the conducting material may be in ranges that are commonly used in lithium batteries.

A positive electrode current collector may be any current collector so long as it has high conductivity without causing chemical changes in the battery. Examples of the positive electrode current collector include stainless steel, aluminum, nickel, titanium, sintered carbon, and aluminum or stainless steel that is surface-treated with carbon, nickel, titanium, or silver. The positive electrode current collector may be processed to have fine irregularities on surfaces thereof so as to enhance adhesive strength of the positive electrode current collector to the positive active material, and may be used in any of various forms including films, sheets, foils, nets, porous structures, foams, and non-woven fabrics. The positive electrode current collector may have a thickness of about 3 μm to about 500 μm.

The negative electrode may be manufactured as follows. For example, a negative active material, a binder, a solvent, and a conducting agent may be mixed to prepare a negative active material composition. The negative active material composition may be coated directly on a current collector (for example, a Cu current collector), or may be cast on a separate support to form a negative active material film, which may then be separated from the support and laminated on a Cu current collector to obtain the negative electrode.

Examples of the negative active material include materials allowing intercalation and deintercalation of lithium ions, such as graphite, carbon, lithium metal, lithium-containing alloys, and silicon oxide-based materials.

The binder can facilitate binding between the negative active material and the conducting agent, and binding of the negative active material to the current collector. Examples of the binder include polyvinylidene fluoride (PVDF), polyvinyl alcohols, carboxymethylcellulose (CMC), starch, hydroxypropylcellulose, regenerated cellulose, polyvinylpyrollidone, tetrafluoroethylene, polyethylene, polypropylene, ethylene-propylene-diene terpolymer (EPDM), sulfonated EPDM, styrene butadiene rubber, fluoro rubber, and various copolymers.

The solvent and the conducting agent may be any of solvents and conducting agents commonly used in batteries. For example, the solvent and the conducting agent may be the same as those used to form the positive electrode.

The amounts of the negative active material, the binder, the solvent, and the conducting material may be in ranges that are commonly used in lithium batteries.

The negative electrode current collector is not particularly limited, and may be any appropriate material so long as it has a suitable conductivity without causing chemical changes in the battery. Examples of the negative electrode current collector include copper, stainless steel, aluminum, nickel, titanium, sintered carbon, copper or stainless steel that is surface-treated with carbon, nickel, titanium, or silver, and aluminum-cadmium alloys. In addition, similar to the positive electrode current collector, the negative electrode current collector may be processed to have fine irregularities on surfaces thereof so as to enhance adhesive strength of the negative electrode current collector to the negative active material, and may be used in any of various forms including films, sheets, foils, nets, porous structures, foams, and non-woven fabrics. The negative electrode current collector may have a thickness of about 3 μm to about 500 μm.

If required, a plasticizer may be added to at least one of the positive active material composition and the negative active material composition to form pores in the electrode plates.

The separator may be positioned between the positive electrode and the negative electrode according to the type of the lithium battery. Any separator commonly used for lithium batteries may be used. In an embodiment, the separator may have low resistance to migration of ions in an electrolyte and a high electrolyte-retaining ability. Examples of materials used to form the separator include glass fiber, polyester, Teflon, polyethylene, polypropylene, polytetrafluoroethylene (PTFE), and combinations thereof, each of which may be a nonwoven or woven fabric. For example, a rollable separator formed of polyethylene or polypropylene may be used for lithium ion batteries. In addition, a separator having a good organic electrolyte retaining capability may be used for lithium ion polymer batteries.

The separator may be formed as follows. A polymer resin, a filler, and a solvent are mixed to prepare a separator composition. Then, the separator composition may be coated directly on an electrode, and then dried to form a separator film. Alternatively, the separator composition may be cast on a separate support and then dried to form a separator composition film, which is then removed from the support and laminated on an electrode to form a separator film.

The polymer resin may be any suitable material that is commonly used as a binder for electrode plates. Examples of the polymer resin include a vinylidenefluoride/hexafluoropropylene copolymer, polyvinylidenefluoride, polyacrylonitrile, polymethylmethacrylate, and mixtures thereof. However, any suitable polymer resin may be used. For example, a vinylidenefluoride/hexafluoropropylene copolymer containing about 8 to about 25 wt % of hexafluoropropylene may be used.

The separator may be positioned between the positive electrode plate and the negative electrode plate to form a primary assembly, which is then wound or folded. The primary assembly is then encased in a cylindrical or rectangular battery case. Then, an electrolyte is injected into the battery case, thereby completing manufacturing of a lithium battery assembly. Alternatively, a plurality of such primary battery assemblies may be laminated to form a bi-cell structure and impregnated with an organic electrolyte. Then, the resulting structure may be encased in a pouch and sealed, thereby completing manufacturing of a lithium battery assembly.

The term “primary assembly” used herein indicates an assembly of negative and positive electrodes having a particular structure before the electrolyte is injected.

The electrolyte, which is used to manufacture the lithium battery assembly, may include a non-aqueous organic solvent and a lithium salt.

The non-aqueous organic solvent may act as a migration medium of lithium ions involved in electrochemical reactions in lithium batteries. Examples of the non-aqueous organic solvent include a carbonate-based solvent, an ester-based solvent, an ether-based solvent, a ketone-based solvent, an alcohol-based solvent, and an aprotic solvent.

Examples of the carbonate-based solvent include dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), and butylene carbonate (BC). However, any suitable carbonate-based solvent may be used.

Examples of the ester-based solvent include methyl acetate, ethyl acetate, n-propyl acetate, dimethyl acetate, methyl propionate, ethyl propionate, γ-butyrolactone (GBL), decanolide, valerolactone, mevalonolactone, and caprolactone. However, any suitable ester-based solvent may be used.

Examples of the ether-based solvent include dibutyl ether, tetraglyme, diglyme, dimethoxy ethane, 2-methyltetrahydrofuran, and tetrahydrofuran. However, any suitable ether-based solvent may be used.

An example of the ketone-based solvent is cyclohexanone. However, any suitable ketone-based solvent may be used.

Examples of the alcohol-based solvent include ethyl alcohol, and isopropyl alcohol. However, any suitable alcohol-based solvent may be used.

Examples of the aprotic solvent include nitriles (such as R—CN, wherein R is a C₂-C₂₀ linear, branched, or cyclic hydrocarbon-based moiety that may include a double-bonded aromatic ring or an ether bond), amides (such as dimethylformamide), dioxolanes (such as 1,3-dioxolane), and sulfolanes. However, any suitable aprotic solvent may be used.

The non-aqueous organic solvent may include a single solvent used alone or a combination of at least two solvents. If a combination of at least two solvents is used, a mixing ratio of the at least two of the non-aqueous organic solvents may vary according to desired performance of the lithium battery, which will be obvious to one of ordinary skill in the art.

For example, the non-aqueous organic solvent may be a mixture of ethylene carbonate (EC) and ethylmethyl carbonate (EMC) in a volume ratio of 3:7. For example, the non-aqueous organic solvent may be a mixture of EC, GBL, and EMC in a volume ratio of 3:3:4.

The lithium salt of the electrolyte may be dissolved in the non-aqueous organic solvent and can operate as a source of lithium ions in the battery. The lithium salt can also accelerate migration of lithium ions between the positive electrode and the negative electrode.

For example, the lithium salt may include at least one supporting electrolyte salt selected from the group consisting of LiPF₆, LiBF₄, LiSbF₆, LiAsF₆, LiN (SO₂C₂F₅)₂, Li (CF₃SO₂)₂N, LiC₄F₉SO₃, LiClO₄, LiAlO₂, LiAlCl₄, LiN (CₓF₂ₓ₊₁SO₂)(C_{y}F_{2y+1} SO₂) (where x and y are each independently a natural number), LiCl, LiI, and LiB (C₂O₄)₂ (lithium bis(oxalato) borate or LiBOB). Combinations of electrolyte salts may be used.

Concentration of the lithium salt may be in a range of about 0.1 M to about 2.0 M. For example, the concentration of the lithium salt may be from about 0.6 M to about 2.0 M. When the concentration of the lithium salt is within these ranges, the electrolyte may have the desired conductivity and viscosity, and thus lithium ions may efficiently migrate.

The electrolyte may further include an additive capable of improving low-temperature performance of the lithium battery. Examples of the additive include a carbonate-based material and propane sulton (PS). However, any suitable additive may be used. Furthermore, one additive may be used, or a combination of additives may be used.

Examples of the carbonate-based material include vinylene carbonate (VC); vinylene carbonate (VC) derivatives having at least one substituent selected from the group consisting of halogen atoms (such as —F, —Cl, —Br, and —I), cyano groups (CN), and nitro groups (NO₂); and ethylene carbonate (EC) derivatives having at least one substituent selected from the group consisting of halogen atoms (such as —F, —Cl, —Br, and —I), cyano groups (CN), and nitro groups (NO₂). However, any suitable carbonate-based material may be used.

The electrolyte may further include at least one additive selected from the group consisting of vinylene carbonate (VC), fluoroethylene carbonate (FEC), and propane sulton (PS).

The amount of the additive may be 10 parts or less by weight based on 100 parts by weight of the total amount of the non-aqueous organic solvent and the lithium salt. For example, the amount of the additive may be in a range of about 0.1 parts by weight to about 10 parts by weight based on 100 parts by weight of the total amount of the non-aqueous organic solvent and the lithium salt. When the amount of the additive is within these ranges, the lithium battery may have satisfactory low-temperature characteristics.

For example, the amount of the additive may be in a range of about 1 part by weight to about 5 parts by weight based on 100 parts by weight of the total amount of the non-aqueous organic solvent and the lithium salt. The amount of the additive may be in a range of about 2 parts by weight to about 4 parts by weight, based on 100 parts by weight of the total amount of the non-aqueous organic solvent and the lithium salt.

For example, the amount of the additive may be 2 parts by weight based on 100 parts by weight of the total amount of the non-aqueous organic solvent and the lithium salt.

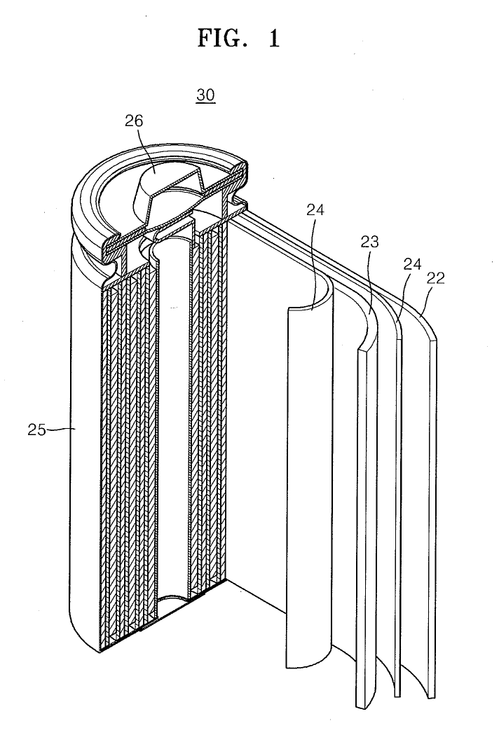

FIG. 1 is a schematic perspective view of a lithium battery 30 according to an embodiment of the present invention. Referring to FIG. 1, the lithium battery 30 includes an electrode assembly having a positive electrode 23, a negative electrode 22, and a separator 24 between the positive electrode 23 and the negative electrode 22. The electrode assembly is contained within a battery case 25, and a sealing member 26 seals the battery case 25. An electrolyte (not shown) may be injected into the battery case 25 to impregnate the electrolyte assembly. The lithium battery 30 may be manufactured by sequentially stacking the positive electrode 23, the negative electrode 22, and the separator 24 on one another to form a stack, rolling the stack into a spiral form, and inserting the rolled up stack into the battery case 25.

Thereinafter, one or more embodiments of the present invention will be described in detail with reference to the following examples. However, these examples are not intended to limit the scope of the one or more embodiments of the present invention.

### Example 1

NiSO₄, CoSO₄, and MnSO₄, each having 99% purity, were mixed to contain about 2M to about 4M of Ni, Co, and Mn in a mixture. Then, a 7M NaOH aqueous solution and a 1M NH₄OH aqueous solution were added to the mixture and mixed altogether. The mixture was co-precipitated at pH 11 and about 800 rpm to obtain a nickel-based composite oxide precursor. The nickel-based composite oxide precursor was washed, dried at a 120° C. oven, and filtered. Li₂CO₃ was then added thereto in a ratio of 1:1 by weight to the nickel-based composite oxide precursor, and mixed using a mixer. The mixture was put in a sintering container. The temperature was raised at a rate of 5° C./min up to about 900° C., and the mixture was sintered at that temperatures for about 15 hours to obtain a positive active material.

The positive active material was analyzed by scanning electron microscopy (SEM) to identify a particle diameter distribution of the positive active material.

The positive active material, a polyvinylidene fluoride (PVDF) binder, and a carbon conducting agent were dispersed in a weight ratio of 96:2:2 in an N-methylpyrrolidone solvent to prepare positive electrode slurry. The positive electrode slurry was coated on an aluminum (Al)-foil to form a thin positive electrode plate having a thickness of 60 μm, dried at 135° C. for 3 hours or longer, and rolled to manufacture a positive electrode plate.

The positive active material of the positive electrode plate was analyzed by SEM to identify the particle diameter distribution of the positive active material.

A specific surface area, porosity, density, and compressive fracture strength (CFS) of the positive active material of the positive electrode plate were measured.

A coin cell with the positive electrode plate as a positive electrode and a Li-metal negative electrode was manufactured.

The thermal stability of the coin cell was measured by differential scanning calorimetry (DSC). The capacity reduction rate of the coin cell after 45 cycles was also measured.

### Comparative Example 1

A coin cell was manufactured in the same manner as in Example 1, except that NEG10 (available from LNF Ltd.) was used as a positive active material.

The average particle diameter D₅₀, specific surface area, porosity, density, and compressive fracture strength (CFS) were measured after rolling the positive active materials of Example 1 and Comparative Example 1. The results are shown in Table 1.

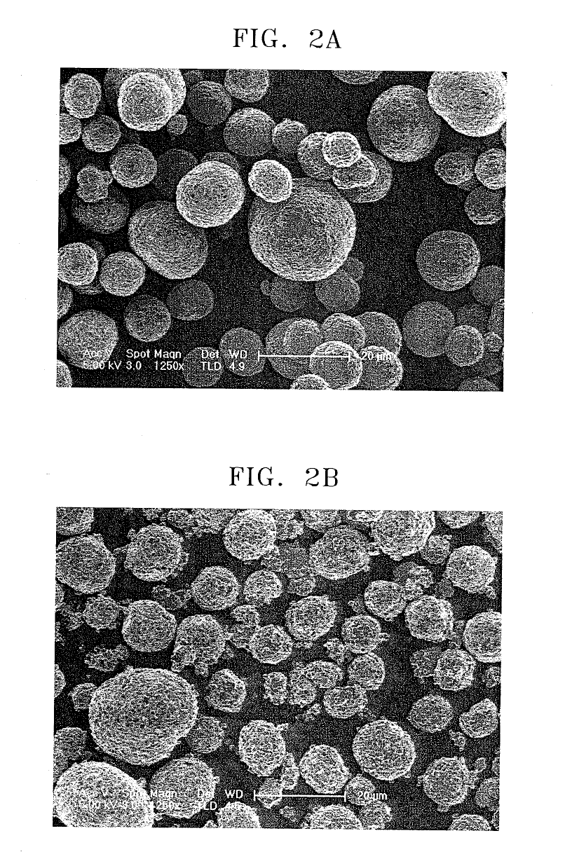

SEM images of the positive active material of Example 1 before and after rolling are shown in FIGS. 2A and 2B, respectively.

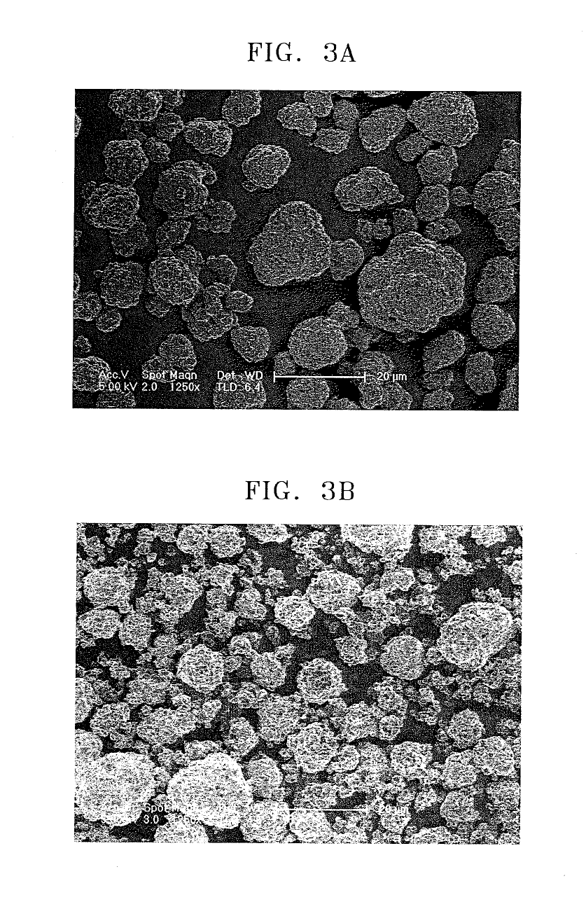

SEM images of the positive active material of Comparative Example 1 before and after rolling are shown in FIGS. 3A and 3B, respectively.

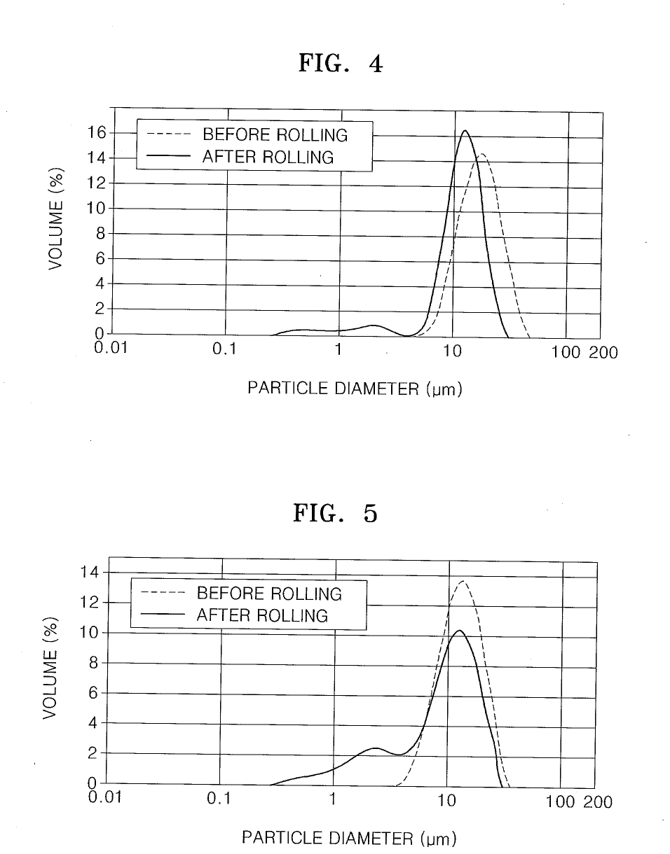

Particle diameter distributions of the positive active material of Example 1 before and after rolling are shown in FIG. 4.

Particle diameter distributions of the positive active material of Comparative Example 1 before and after rolling are shown in FIG. 5.

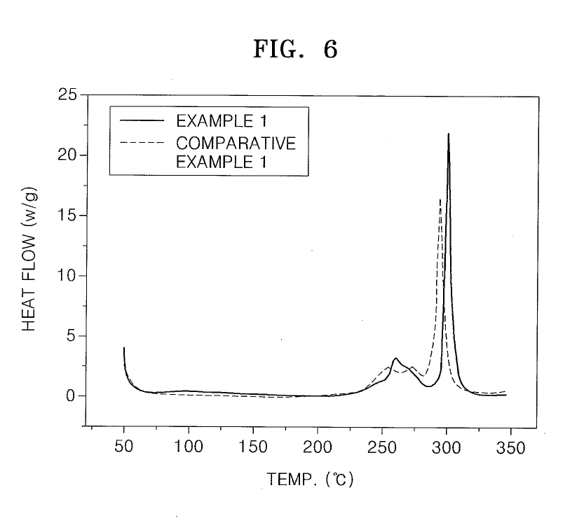

The coin cells of Example 1 and Comparative Example 1 were analyzed by differential scanning calorimetry (DSC). The results are shown in FIG. 6.

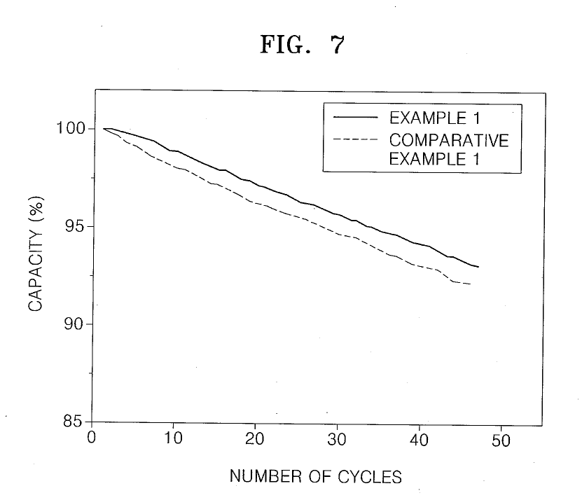

The capacities of the lithium batteries of Example 1 and Comparative Example 1 with respect to the number of charge and discharge cycles were measured. The results are shown in FIG. 7.

TABLE 1

| | | Specific | | | |
|---|---|---|---|---|---|
| | Average particle | surface | | | |
| | diameter D₅₀ | area | Porosity | Density | CFS |
| | (μm) | (m²/g) | (%) | (g/cm³) | (MPa) |
| Example 1 | 11 | 0.3 | 0.33 | 3.21 | 55 |
| Comparative | 10 | 0.3 | 0.32 | 3.2 | 54 |
| Example 1 | | | | | |

Referring to Table 1, the positive active materials of the positive electrode plates of Example 1 and Comparative Example 1 are similar to each other in specific surface area, porosity and density. However, the positive active material of Example 1 has an average particle diameter D50 and a CFS that is slightly larger than that of the positive active material of Comparative Example 1.

Referring to FIGS. 2A, 2B, 3A and 3B, the positive active material of Example 1 is found to have been broken less by rolling than the positive active material of Comparative Example 1.

Referring to FIGS. 4 and 5, the positive active material of Example 1 is found to contain merely about 1 wt % or less of particles having a diameter of 1 μm or less after the rolling, indicating fine particles are very unlikely to be generated from rolling the positive active material of Example 1.

Referring to FIG. 6, the positive active material of Example 1 has a similar on-set temperature of about 235° C. as that of the positive active material of Comparative Example 1. However, the main peak temperature of the positive active material of Example 1 appears at a temperature about 10° C. higher than the main peak temperature of the positive active material of Comparative Example 1. In addition, the positive active material of Example 1 produces less heat than the positive active material of Comparative Example 1.

Referring to FIG. 7, the positive active material of Example 1 has better lifetime characteristics than the positive active material of Comparative Example 1.

As described above, a lithium battery including the positive electrode plate according to the one or more of the above described embodiments may experience less side reactions, and thus, be improved in charge and discharge characteristics and stability.

It should be understood that embodiments described herein should be considered in a descriptive sense only and not for purposes of limitation. Descriptions of features or aspects within each embodiment should typically be considered as available for other similar features or aspects in other embodiments.

What is claimed is:

1. A positive electrode plate comprising particles of a nickel-based composite oxide represented by Formula 1, wherein the particles have an average particle diameter D₅₀ of about 10 μm to about 20 μm, and wherein 1 wt % or less of the particles has a diameter of about 5 μm an or less:
LiNiₓCo_{y}Mn_{1-x-y}O₂ Formula 1:
wherein 0<x<1.0, 0<y<1.0, and x+y<1.

2. The positive electrode plate of claim 1, wherein the particles have a spherical particle shape and a specific surface area of about 0.2 m²/g to about 0.5 m²/g.

3. The positive electrode plate of claim 1, wherein the nickel-based composite oxide has a porosity of about 1% to about 40%.

4. The positive electrode plate of claim 1, wherein the nickel-based composite oxide has a density of about 1 g/cm³ to about 5 g/cm³.

5. The positive electrode plate of claim 1, wherein in Formula 1, x is from 0.3 to 0.65, and y is less than 0.35.

6. The positive electrode plate of claim 1, wherein the nickel-based composite oxide has a compressive fracture strength (CFS) of about 50 MPa to about 300 MPa.

7. The positive electrode plate of claim 1, wherein the nickel-based composite oxide has a compressive fracture strength (CFS) of about 50 MPa to about 100 MPa.

8. A method of manufacturing a positive electrode plate, the method comprising:
providing a mixed solution comprising a nickel (Ni)-containing compound, a cobalt (Co)-containing compound, a manganese (Mn)-containing compound, a precipitating agent, and a chelating agent;
co-precipitating the mixed solution at a pH of about 10 to about 12 to obtain a nickel-based composite oxide precursor;
mixing and sintering the nickel-based composite oxide precursor and a lithium-containing compound to obtain a nickel-based composite oxide;
coating the nicked-based composite oxide on a current collector; and
drying and rolling the coated current collector.

9. The method of claim 8, wherein the Ni-containing material comprises at least one compound selected from the group consisting of nickel oxides, nickel hydroxides, nickel carbonates, nickel nitrides, nickel sulfides, nickel halides, and carboxylic acid nickel salts,
wherein the Co-containing material comprises at least one compound selected from the group consisting of cobalt oxides, cobalt hydroxides, cobalt halides, and carboxylic acid cobalt salts, and
wherein the Mn-containing compound comprises at least one compound selected from the group consisting of manganese oxides, manganese carbonates, manganese nitrides, manganese sulfides, manganese halides, and carboxylic acid manganese salts.

10. The method of claim 9, wherein the sintering is performed at a temperature of about 800° C. to about 1000° C.

11. The method of claim 9, wherein the nickel-based composite oxide precursor and the lithium-containing compound are mixed in a ratio of about 1:1 to about 1.1:1 by weight.

12. The method of claim 8, wherein the nicked-based composite oxide is represented by Formula 1, wherein Formula 1=LiNiₓCo_{y}Mn_{1-x-y}O₂, and wherein 0<x<1.0, 0<y<1.0, and x+y<1.

13. The method of claim 12, wherein the nicked-based composite oxide comprises particles having an average particle diameter D₅₀ of about 10 μm to about 20 μm, and wherein 1 wt % or less of the particles has a diameter of about 5 μm or less.

14. The method of claim 13, wherein the particles have a spherical particle shape and a specific surface area of about 0.2 m²/g to about 0.5 m²/g.

15. A lithium battery comprising:
a positive electrode comprising the positive electrode plate of claim 1;
a negative electrode; and
a separator between the positive and negative electrodes.
